(19) United States
(12) Patent Application Publication
(10) Pub. No.: US 2015/0072764 A1
(43) Pub. Date: Mar. 12, 2015

(54) Systems and Methods for Providing, Accessing and Reporting for a Group eWallet

(71) Applicant: Bally Gaming, Inc., Las Vegas, NV (US)

(72) Inventor: Gururaj Sunkada, Bangalore (IN)

(73) Assignee: Bally Gaming, Inc., Las Vegas, NV (US)

(21) Appl. No.: 14/024,281

(22) Filed: Sep. 11, 2013

(51) Int. Cl. G07F 17/32

(52) U.S. Cl. CPC G07F 17/3244
USPC 463/25

(57) ABSTRACT

Gaming systems and methods are set forth for players or customers to form groups and invoke a shared group electronic fund accessible by the players or customers for commerce. The commercial enterprise or players may establish competitive tournaments between groups with prizes to be awarded. Each member of the group has defined access and may view group data in real time, if desired.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The field of the invention relates to systems and methods directed toward creation, funding, accessing, managing and activity reporting related to a group electronic fund account referred to herein as a group eWallet. More particularly it relates to systems and methods which are directed toward creation, funding, accessing, managing and activity reporting for an eWallet configured for use in relation to a casino enterprise including pay-to-play gaming (“P2P”) and other spending at the enterprise physical, brick and mortar, venue, online/mobile gaming where legal and other designated activities and for use in competitive or social intercourse. It also relates to establishing competition tournaments between established groups.

2. Background

In modern casino enterprises which may include several physical casino venues, players may enroll in the casino loyalty program. Enrollment is done on an individual basis; however at enrollment family members may be linked. Typically the enterprise seeks to use the program to market to the player and hence individual player activity such as gaming or spending for hotel, meals, souvenirs and the like is tracked to quantify the value of the player to the casino and for marketing.

The casino enterprise includes a communication network by which an operator can monitor player activity such as wagers, jackpots, games played and other spending. Players are identified typically through the player's use of a loyalty card having a machine readable stripe. For a brick and mortar casino an example of such a system is the Bally CMS® system sold by Bally Technologies, Inc. of Las Vegas, Nev. These systems interface with card readers at gaming terminals and table game input devices and at point-of-sale registers to provide the aforesaid tracking functions. Based upon the data collected the casino can track the player's spending as well as provide bonuses to players in the way of benefits and incentives to retain a player's loyalty by, for example, awarding “comps” in the form of cash back, discounts for goods, lodging, meals, services and gifts or points which can be exchanged for the foregoing. The tracking can be restricted to a single enterprise venue or can be on a national basis such as described in Boushy, U.S. Pat. No. 7,419,427 issued Sep. 2, 2008 and titled “National Customer Recognition System and Method”, the disclosure of which is incorporated by reference. The level of “comps” available to the player is related to the player's rating which acts to quantify the value of the player to the casino. A rating may be based upon the value of the player to the casino based upon his/her “spend” with the enterprise. A higher rated player is one who spends and gambles more than a lower rated player. A higher rated player is entitled to more valuable or additional comps. A player's rating is individual. That is, a husband may have a higher rating that his wife based upon his/her activities. There is no “group”, composite, rating for groups or even family groups.

For P2P gaming at a brick and mortal casino venue, each player funds their gaming individually by inserting value (cash/coin/voucher) at a gaming device or establishing an electronic account funded with cash or credit. For P2P remote gaming (where legal) again the player may establish an individual account through cash or credit. To avoid disputes and for security a player's account is not accessible by other players including family members.

Because activities at casino enterprises are focused upon entertainment there is need to enable socializing between friends and family. In addition to the individual tracking referenced above, it would be advantageous if players could form groups of family/friends and share their activities at least inter se. In this regard it would be advantageous that certain individual activities of the members within the group could be tracked by the other members of the group such as, for example, jackpots won by a group member, winnings, spending or the like. It would also be advantageous if the members of the group could fund a common account which could be shared, with perhaps limits, among the players to fund activities such as gaming, dining or other spending. For example a family of four visiting Las Vegas could establish and fund a group account from which members could withdraw funds from and credit funds to the account. Still further it would be advantageous to enable groups or sub-groups within a group to compete against one another for prizes or for entertainment purposes. In this regard any grouping could be carried over into social media or internet activities particularly in regards to the hosting enterprise.

Aside from the advantages to the players of the group, there would be advantages to the hosting casino since the system architecture to support the system and data would provide opportunities for business intelligence directed toward the members of the group. For example various promotions and tournaments could be offered to groups and their members to foster brand loyalty and consumer spending. Further player grouping would draw family and friends into their group bringing more customers to the enterprise.

The feature of providing for consumers to form groups may also have advantages outside of the gaming environment. For example, businesses such as gasoline station and grocery chains may take advantage of permitting customers to group to their advantage to obtain promotions and discounts. As the “grouped” consumers spend with the enterprise toward achieving milestones or goals the enterprise gains customers and promotes brand loyalty. Controls could be provided in regards to eWallet spending by the group or any member to avoid exploitation by any one or more members to the detriment of the others.

### SUMMARY OF THE INVENTION

There is, therefore, provided in accordance with one aspect of the present invention a system and method for providing group features to players for a casino enterprise hosting a plurality of gaming terminals. The gaming terminals may be gaming devices at a brick and mortar casino or may be PCs or portable devices configured for gaming as by, for example, a smart phone operating and suitable gaming application. Each terminal has apparatus for identifying a player at a gaming terminal. In a casino this may be a magnetic stripe reader configured to read a loyalty card held by and attributed to the player. The system includes a host computer and data structure storing data corresponding to an account established for each player and a communication network for providing communication between the terminals and the host computer. The communication network may be a wide area network (WAN) or local area network (LAN) at a brick and mortar casino, the Internet and/or a broadband communication network. In regards to player interaction with the enterprise many players possess portable devices having a processor, display and memory. In particular these devices may be cellular devices such as smart phones, tablets, mini tablets and the like. According to various embodiments of the present invention includes a system interface at each gaming terminal providing for player access to the host computer. For a gaming terminal such as a slot machine at a brick and mortar casino the system interface is an interface between the machine and the system. Where the gaming terminal is a remote device such as a PC, tablet or smart phone the interface may be a “window” defined at the device, a display driven by a suitable application on a smart phone or the like. Apparatus in communication with the host computer is configured to define at one or more of the host computer and data structure player account groups N₁-N_{X} and to provide for each a group to fund an eWallet, each group including two or more players. The apparatus may be an enrollment terminal, gaming device, kiosk, web page, smart phone application or the like. The player portable devices are configured to wirelessly communicate with one or both of the gaming terminals and host computer. For example, the communication may be via an Internet portal. Where the device is a smart phone communication may be via broadband with a suitable receiver associated with the host computer or preferably the smart phone communicates with a system connected near field device at the gaming terminal.

The system interface and player portable devices are configured to access a player group by a constituent player thereof to transfer funds between their group eWallet and the gaming terminal. The transfer may be to upload or download funds. The host computer and data structure are configured to record any transaction and constituent player information. Preferably the recordation identifies the player, group and transaction details. Further the gaming terminals, system host and data structure are configured to track and record gaming activity data for each player of a group account and aggregate group account activity.

To provide for the group players to monitor group and group constituent player activities the host computer is configured to provide data over a network to at least one of a gaming terminal video display, remote device display and/or portable device display to display data corresponding to said group account activity and activity for each player account. For example, group aggregate spending as well and each individual of the group spending may be tracked and displayed. Preferably the data displayed is data captured is displayed in real time so players of a group can view real time group and constituent player activities.

In an embodiment the host computer may be configured to establish a group competition parameter such a group awards or group spending and to compare for participating account groups to the parameter. This feature enables the enterprise or player groups to configure competitive tournaments and to award prizes or benefits to one or more winning groups.

In an embodiment players may add or subtract players from their group. They may also create sub-groups within a group with the features referenced above.

In an embodiment established groups may also set up competitions with other groups such as groups competing for winning the most during a time period at a game such as Roulette, Blackjack or other gaming.

In an embodiment the host computer may be configured for circulating targeted promotions to groups. For example, where the tracked information for a group indicates that the players prefer Blackjack, promotions (such a tournaments) may be offered to the group members as well as perhaps a slot tournament to encourage the constituent players to branch out to play slot machines. Another example would be where the tracked information indicates the group plays on Fridays to issue a promotion to encourage play on other days. Other group promotions may be dining promotions, shows and the like which can be attended by the group.

The methods and systems can also be configured for enterprises other than gaming. As but an example a grocery store chain may permit the establishment of groups by customers. The spending and tendencies of the customers of the group are tracked and analyzed for configuring promotions and for group competition promotions.

Other features and numerous advantages of the various embodiments will become apparent from the following detailed description when viewed in conjunction with the corresponding drawings.

### BRIEF DESCRIPTION OF THE DRAWINGS

FIG. 1 illustrates a gaming terminal;

FIGS. 2A-B illustrate an example of a gaming terminal operational platform and components for a gaming terminal of the type of the present invention;

FIG. 3 is a block diagram of the logical components of a gaming kernel for a gaming terminal.

FIGS. 4A and 4B is a schematic of an example of a casino enterprise network incorporating gaming terminals;

FIG. 5 is a diagram showing an example of an architecture for tying a casino enterprise network to an external provider of games and content to Internet or broadband communication capable devices;

FIG. 6 is a logic diagram illustrating the configuration of player group accounts;

FIG. 7 illustrates an arrangement of player accounts and sub-accounts for a group account;

FIGS. 8A, B illustrate alternate arrangements of account data for groups according to embodiments of the invention;

FIG. 9 is a logic diagram showing access to group, sub-group and constituent player accounts; and

FIG. 10 is a logic diagram showing arrangements for group supported tournaments and contests.

### DETAILED DESCRIPTION

While the present invention is primarily described with reference to a casino enterprise, it should be understood that the present invention and its various embodiments could be extended to other enterprises such as stores, service providers or other businesses which deal with repeat business customers and which desire to foster customer loyalty, entice the customer interaction and to expand their customer base.

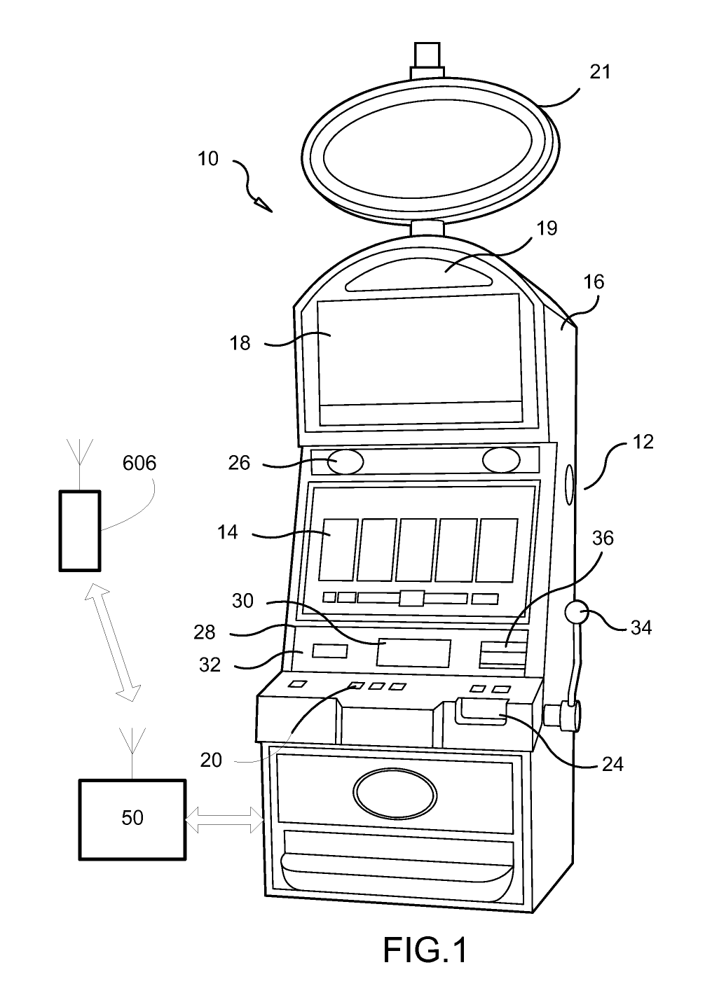

Referring now to the drawings, wherein like reference numbers denote like or corresponding elements throughout the drawings, and more particularly referring to FIG. 1, a gaming device 10 according to one or more embodiments of the present invention is shown. The gaming device 10 is configured, as is well known, to accept a wager, provide for the play of a game and produce (usually randomly, pseudo-randomly) a winning or losing outcome. For a losing outcome the player receives no award. For a winning outcome the player receives an award usually an award measured in game credits. For certain jackpot awards a “hand pay” in cash by casino personnel may be required. The gaming device 10 includes a cabinet 12 providing an enclosure for the several components of the gaming device 10 and associated equipment. A primary game display 14 is mounted to the cabinet 12. The primary game display 14 may be a video display such as an LCD, plasma, OLED or other electronic display or it may be an electro-mechanical display such as electro-mechanical stepper reels as are known in the art. The primary game display 14 may also be embodied as a combination of two or more electronic or mechanical displays disposed in an adjacent overlapping or overlying arrangement. The primary game display 14 may be mounted to one or more of a door for the cabinet 12 or the cabinet chassis itself. The primary game display 14 is located to display game content (and if desired other content) to the player. For example, the game content may be game outcomes presented by a plurality of video or electro-mechanical reels displaying symbols the combinations of which define winning or losing outcomes, video Poker, Keno or other form of base casino wagering game as is known in the art. Where the primary game display 14 is a video display, features such as bonus/feature games may also be presented. The foregoing description should not be deemed as limiting the content (graphics, video or text) which can be displayed at the primary game display 14. The cabinet 12 may comprise a slant-top, bar-top, or table-top style cabinet as is known in the art.

The gaming device 10 also includes in one or more embodiments a top box 16 which may support a printed back-lit glass (not shown) as is known in the art depicting the rules, award schedule, attract graphics or it may support a secondary game display 18 which may be of one of the types described above with reference to the primary game display 14. The top box 16 may also support a backlit glass with graphics defining a marquee 19 and a topper 21 including additional graphics.

To enable a player to provide input to the controller for the gaming device 10 a plurality of buttons 20 may be provided on a button deck for the gaming device 10. Additionally and alternatively one or both of the primary and secondary game displays 14, 18 may include touch screen input devices as are known in the art. Buttons, selections or inputs are displayed at the primary and secondary game displays 14, 18 and the player touching those icons or designated areas provides the required or desired input to configure and play the gaming device 10.

Other peripherals or associated equipment for the gaming device 10 include a bill/voucher acceptor 24 which reads and validates currency and vouchers for the player to establish credits for gaming on the gaming device 10 and one or more speakers 26 to provide audio content to the player in association with the game play. To provide for communication between the gaming device 10 and a casino system, a player tracking module (PTM) 28 is mounted on the cabinet 12. PTM 28 has a PTM display 30 to display system related information to the player. The PTM display 30 may be a small LCD, plasma or OLED display with touch screen functionality to enable the player to communicate with the system. In an embodiment the user interfaces described herein are displayed at the PTM display 30; however, as set forth below these presentations can be migrated to the primary or secondary displays 14, 18. A card reader 32 is provided to read a machine readable component on a player loyalty card (not shown) issued to the player to identify the player to the casino system as in known in the art. A ticket printer 36 may be provided as well on the PTM 28 or elsewhere on the gaming device 10 to provide printed value ticket vouchers to players when they cash out as is also known in the art.

The display and functionality of the PTM 28 may be migrated to the primary display 18 as is disclosed in Kelly et al, U.S. Pat. No. 8,241,123 titled “Video Switcher and Touch Router Method for a Gaming Machine” issued Aug. 14, 2012 and Kelly et al U.S. Pat. No. 8,241,124 titled “Gaming Machine Having a Curved Display With a Video Switcher and Touch Router System”, issued Aug. 14, 2012 the disclosures of which are hereby incorporated by reference. According to these disclosures system and externally based content may be displayed at one or more of the primary or secondary displays 14, 18 dispensing with the need for the PTM display 30. Accordingly it should be understood that the display of information recited herein could be displayed at regions at one or more of the primary or secondary displays 14, 18 in lieu of display at the PTM display

While the player may use the buttons 20 to prompt play of the game (or the touch screen input), alternatively the player may use a handle 34 to prompt an input as is known in the art.

Cabinet 12 may be a self-standing unit that is generally rectangular in shape and may be manufactured with reinforced steel or other rigid materials which are resistant to tampering and vandalism. Any shaped cabinet may be implemented with any embodiment of gaming device 10 so long as it provides access to a player for playing a game. For example, cabinet 12 may comprise a slant-top, bar-top, or table-top style cabinet, including a Bally Cinevision™ or CineReels™ cabinet. The gaming device 10 may include a controller and memory disposed within the cabinet 12 or may have thin client capability such as that some of the computing capability is maintained at a remote server.

The plurality of player-activated buttons 22 may be used for various functions such as, but not limited to, selecting a wager denomination, selecting a game to be played, selecting a wager amount per game, initiating a game, or cashing out money from gaming machine 10. Buttons 22 may be operable as input mechanisms and may include mechanical buttons, electromechanical buttons or touch screen buttons. In one or more embodiments, buttons 22 may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the primary game display 14 and/or secondary game display 18.

The primary game display 14 may present a primary game of chance wherein, for a wager, a player receives one or more outcomes from a set of potential outcomes. For example, one such game of chance is a video slot machine game. In other aspects of the invention, gaming machine 10 may present a video or mechanical reel slot machine, a video keno game, a lottery game, a bingo game, a Class II bingo game, a roulette game, a craps game, a blackjack game, a mechanical or video representation of a wheel game or the like. In a casino environment the base game is most often a pay-to-play (P2P) game meaning that the player must stake a wager to receive either a winning or losing outcome.

While gaming devices 10 as described above at used at brick and mortar casino venues, various aspects of the present invention may also be applied to remote gaming such as Internet and mobile gaming (whether P2P gaming or free, promotional gaming) as well as gaming in or about the casino venue using approved mobile devices such as tablets and the like.

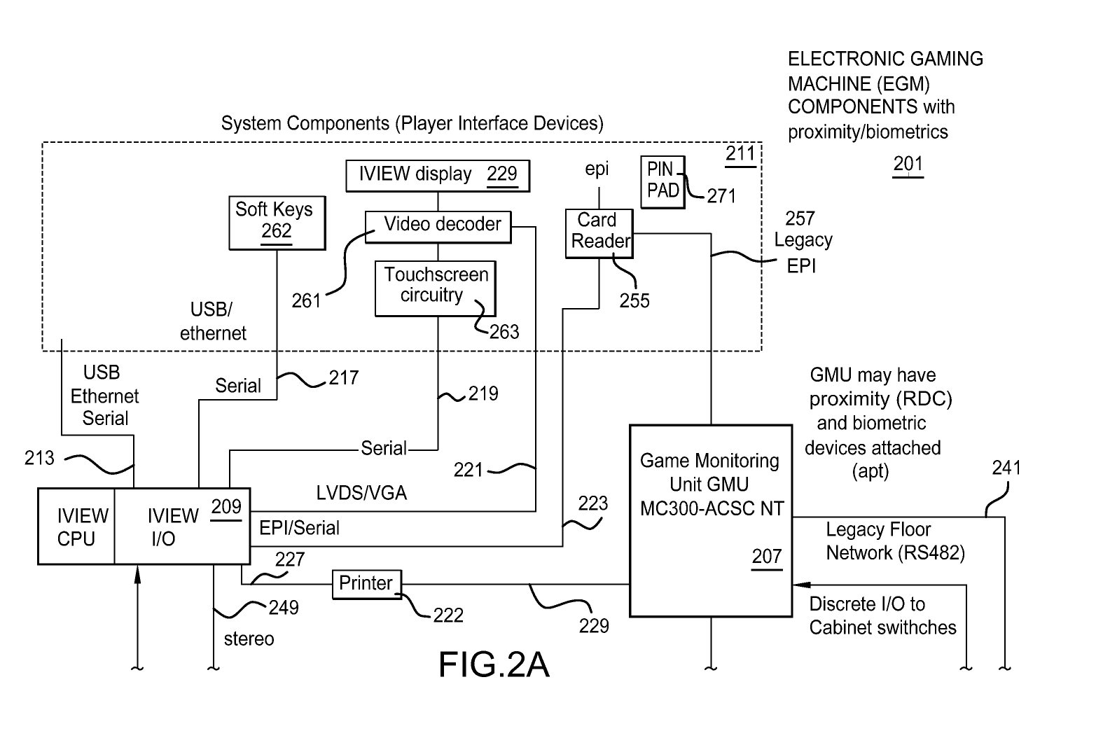

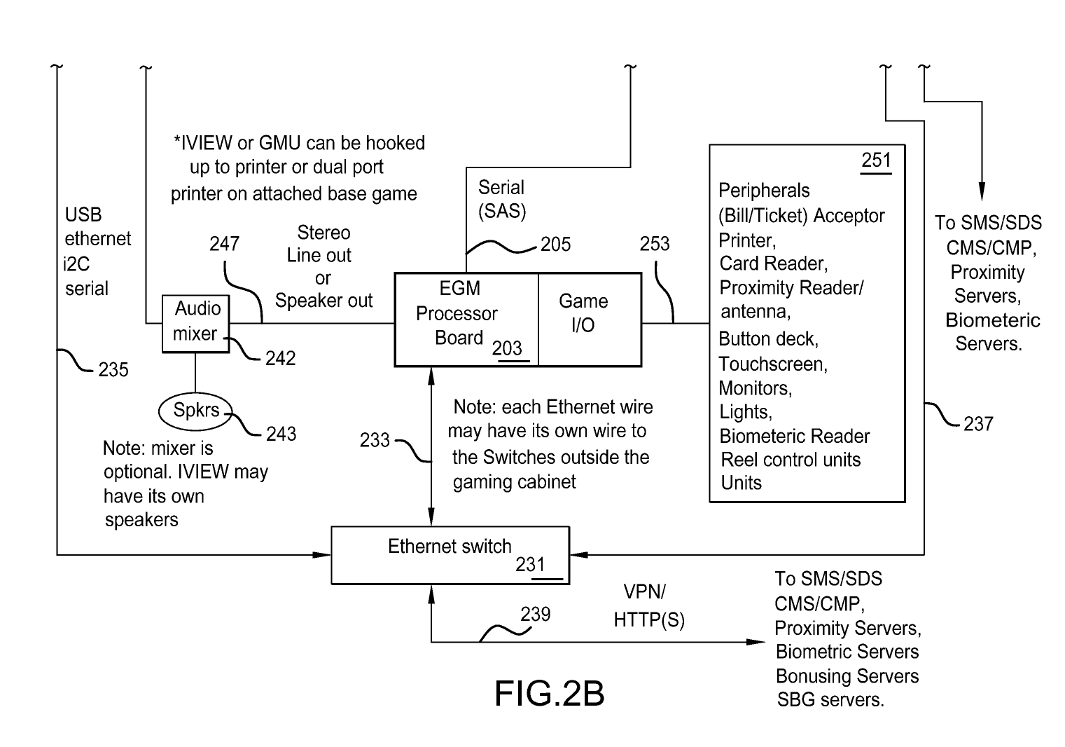

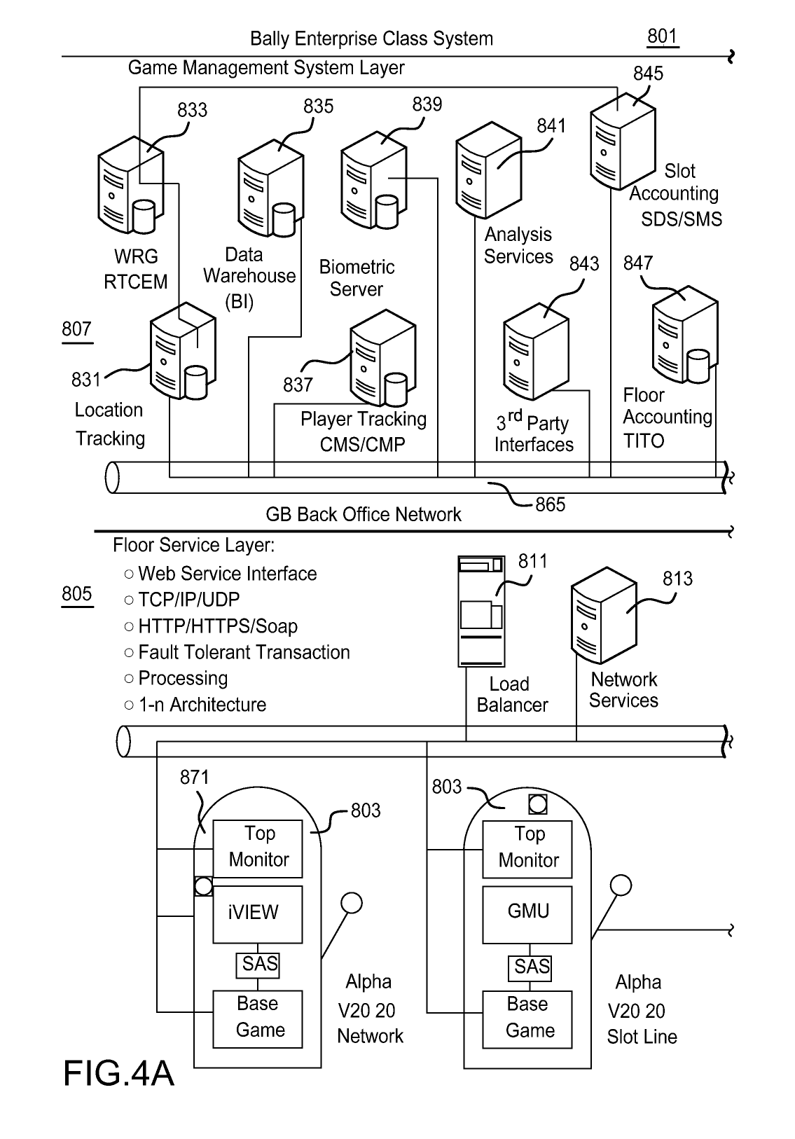

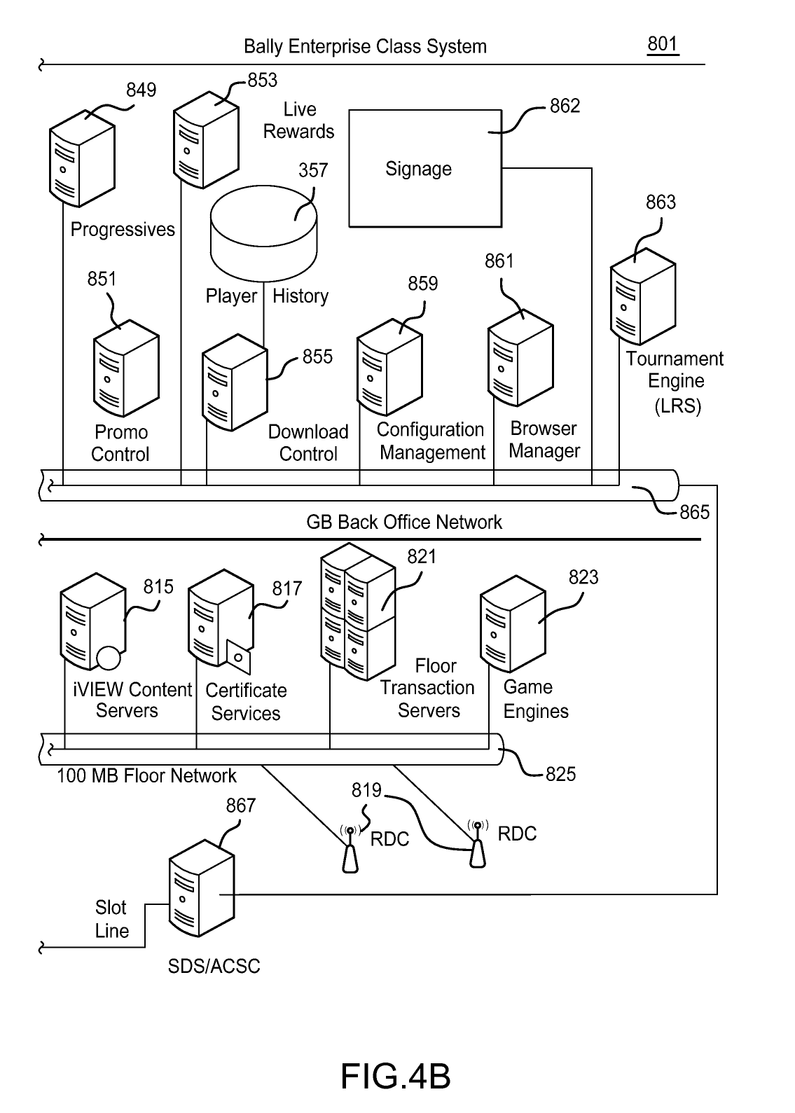

Referring to FIGS. 2A, B, the gaming device 10 hardware 201 for the controller(s) is shown in accordance with one or more embodiments. The hardware 201 includes base game processor board 203 (EGM Processor Board) connected through serial bus line 205 to game monitoring unit (GMU) 207 (such as a Bally MC300 or ACSC NT manufactured and sold by Bally Gaming, Inc., Las Vegas, Nev.). EGM Processor Board 203 is connected to the PID 209 over bus line 249 and PID 209 is connected to the iView device such as 211 in FIG. 2A through bus lines 213, 217, 219, 221, 223. The PID 209 provides for communication between one or more gaming devices 10 and the casino system such as the type as hereinafter described. Inasmuch as gaming devices 10 may be manufactured by different entities, mounting like PTMs 28, 211 and PIDs 209 at each gaming device 10 provides for communication to the system in one or more common message protocols. Typically when a casino enterprise purchases a casino management system they also purchase the same manufacturer's PTMs 28, 211 and PIDs 209 which are then installed by the various manufacturers of the gaming devices 10 for the enterprise before delivery. In this manner the mountings for the PTMs 28, 211 on the gaming devices can be configured for location and esthetic appearance. Gaming voucher ticket printer 36 (for printing player cash out tickets)(shown as 222 in FIG. 2A) is connected to PID 209 and GMU 207 over bus lines 227, 229. EGM Processor Board 203, PID 209 and GMU 207 connect to Ethernet switch 231 over bus lines 233, 235, 237. Ethernet switch 231 connects to a slot management system and a casino management system (SMS, SDS, CMS and CMP) (FIGS. 4A, 4B) network over bus line 239. Ethernet switch 231 may also connect to a server based gaming server or a downloadable gaming server. GMU 207 also may connect to the network over bus line 241. Speakers 26 (shown as 243 in FIG. 2B) to produce sounds related to the game or according to the present invention connect through audio mixer 242 and bus lines 247, 249 to EGM Processor Board 203 and PID 209.

Peripherals 251 connect through bus 253 to EGM Processor Board 203. The peripherals 251 include, but are not limited to the following and may include individual processing capability: bill/voucher acceptor 24 to validate and accept currency and ticket vouchers, the player interfaces such a buttons 20, primary and secondary game displays 14, 18 and any secondary or tertiary displays (with/without) touch screen functionality, monitors and lights. The peripherals 251 may include the displays as hereinafter described with reference to the various embodiments of the present invention as herein described or their equivalents. For example, the bill/voucher acceptor 24 is typically connected to the game input-output board of the EGM processing board 203 (which is, in turn, connected to a conventional central processing unit (“CPU”) board), such as an Intel Pentium® microprocessor mounted on a gaming motherboard. The I/O board may be connected to CPU processor board 203 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 203 executes a game program that causes the gaming device 10 to display and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 253 to the I/O board and to EGM processor board 203 which, in turn, assigns an appropriate number of credits for play in accordance with the game program. The player may further control the operation of the gaming machine by way of other peripherals 251, for example, to select the amount to wager via the buttons 20. The game starts in response to the player operating a start mechanism such as the handle 34, button 20 such as a SPIN/RESET button or a touch screen icon. The game program includes a random number generator to provide a display of randomly selected indicia on one or more displays such as the primary game display 14 as shown in FIG. 1. In some embodiments, the random generator may be physically separate from gaming device 10; for example, it may be part of a central determination host system which provides random game outcomes to the game program. Finally, EGM processor board 203 under control of the game program and OS compares the outcome to an award schedule. The set of possible game outcomes may include a subset of outcomes related to the triggering and play of a feature or bonus game. In the event the displayed outcome is a member of this subset, EGM processor board 203, under control of the game program and by way of I/O Board, may cause feature/bonus game play to be presented on the primary game display 14 and/or any secondary display(s) 18.

Predetermined payout amounts for certain outcomes, including feature game outcomes, are stored as part of the game program. Such payout amounts are, in response to instructions from EGM processor board 203, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the gaming terminal are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 207 includes an integrated circuit board and GMU processor and memory including coding for network communications, such as the G2S (game-to-system) protocol from the Gaming Standards Association, Las Vegas, Nev., used for system communications over the network. As shown, GMU 207 may connect to the card reader 32 (shown as 255 in FIG. 2A) through bus 257 and may thereby obtain player information and transmit the information over the network through bus 241. Gaming activity information may be transferred by the EGM Processor Board 203 to GMU 207 where the information may be translated into a network protocol, such as S2S, for transmission to a server, such as a player tracking server, where information about a player's playing activity may be stored in a designated server database. This information may include time, machine identification data, coin-in, coin-out, jackpots or other information.

PID 209 includes an integrated circuit board, PID processor (iView CPU), and memory which includes an operating system, such as Windows CE, a player interface program which may be executable by the PID 209 processor together with various input/output (I/O) drivers for respective devices which connect to PID processor and which may further include various games or game components playable on PTM 28, 211 or playable on a connected network server and PTM 28, 211 is operable as the player interface. PID 209 connects to card reader 32 (shown as 255 in FIG. 2A) through bus 223, player tracking display 30 (shown as iView display 229 in FIG. 2A) through video decoder 261 and bus 221, such as an LVDS or VGA bus.

As part of its programming, the PID 209 processor executes coding to drive player tracking display 30, 229 and provide messages and information to a player. Touch screen circuitry 263 interactively connects PTM display 30, 229 and video decoder 261 to PTM 28, 211 such that a player may input information and causes the information to be transmitted either on the player's initiative or responsive to a query. Additionally soft keys 262 connect through bus 217 to PID 209 and operate together with the player tracking display 30 to provide information or queries to a player and receive responses or queries from the player. PID 209, in turn, communicates over the CMS/SMS network through Ethernet switch 231 and busses 235, 239 and with respective servers, such as a player tracking server.

PTMs 28 provide a link between the virtual private WAN/LAN network of the system components and the gaming terminal 10. The system components include the player tacking module 28 (e.g. Bally iVIEW® device) (“iView” is a registered trademark of Bally Gaming, Inc.), PID 209, EGM processing board 203 and game monitoring unit (GMU) processing board 207. These system components may connect over a network to the slot management system (such as a commercially available Bally SDS/SMS) and/or casino management system (such as a commercially available Bally CMP/CMS).

The GMU 207 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to installation on the system components.

The system components include the PTM 28 processing board (PID 209) and game monitoring unit (GMU) 207. The GMU 207, PID 209 and PTM 28 can be combined into one like the commercially available Bally GTM iVIEW device. The PTM 28 may also interface with a switcher and router device of the type described above. In such case, instead of providing the PTM display 30, the switcher and router device provides for the content normally display at the PTM display 30 to be displayed at one or more of the primary or secondary displays 14, 18.

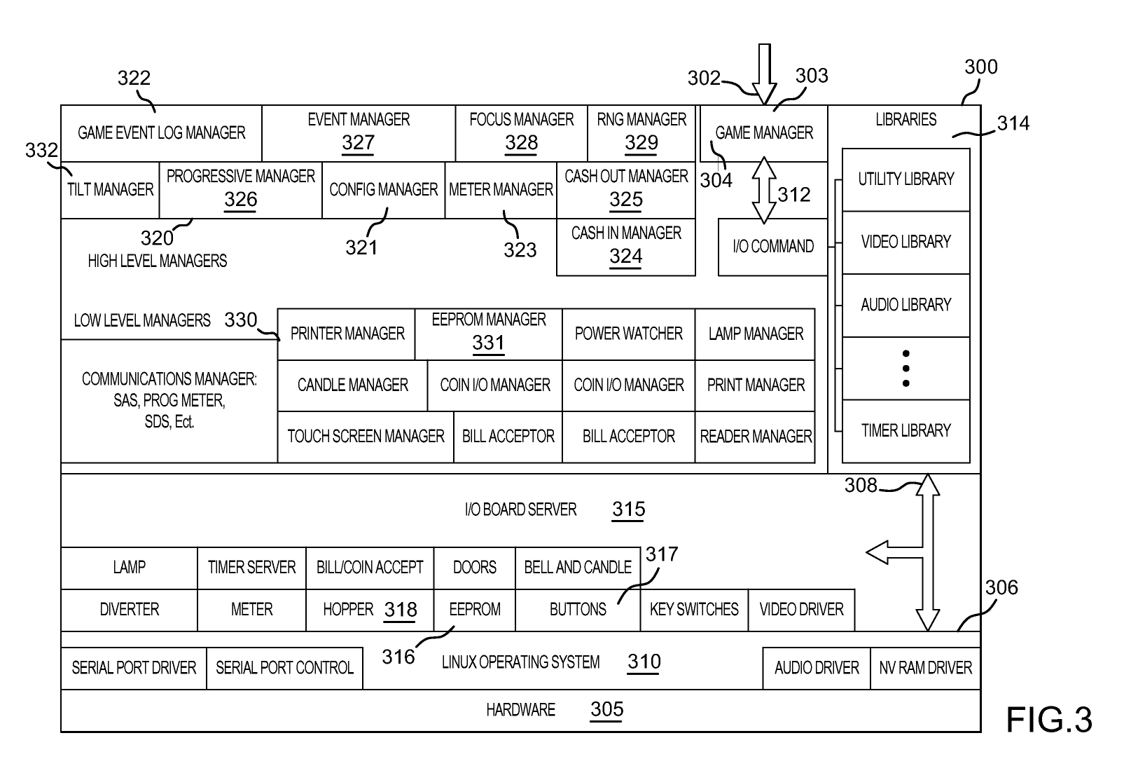

In accordance with one or more embodiments, FIG. 3 is a functional block diagram of a gaming kernel 300 of a game program under control of gaming device EGM processor board 203. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 306; an operating system layer 308, such as, but not limited to, Linux; and a game kernel layer having game manager 304 therein. In one or more embodiments, the use of an operating system layer 310, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 executes at the user level of the operating system layer 308, and itself contains a major component called the I/O board server 315. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 304 parses an incoming command stream and, when a command dealing with I/O comes in (arrow 312), the command is sent to an applicable library routine 314. Library routine 314 decides what it needs from a device, and sends commands to I/O board server 310 (see arrow 308). A few specific drivers remain in operating system layer 310's kernel, shown as those below line 306. These are built-in, primitive, or privileged drivers that are (i) general (ii) kept to a minimum and (iii) are easier to leave than extract. In such cases, the low-level communications is handled within operating system layer 310 and the contents passed to library routines 314.

Thus, in a few cases library routines may interact with drivers inside operating system layer 310, which is why arrow 308 is shown as having three directions (between library routines 314 and I/O board server 315, or between library routines 314 and certain drivers in operating system layer 306). No matter which path is taken, the logic needed to work with each device is coded into modules in the user layer of the diagram. Operating board server layer 306 is kept as simple, stripped down, and common across as many hardware platforms as possible. The library utilities and user-level drivers change as dictated by the game cabinet or game machine in which it will run. Thus, each game cabinet or game machine may have an industry standard EGM EGM processing board 203 connected to a unique, relatively dumb, and as inexpensive as possible I/O adapter board, plus a gaming kernel 300 which will have the game-machine-unique library routines and I/O board server 315 components needed to enable game applications to interact with the gaming machine cabinet. Note that these differences are invisible to the game application software with the exception of certain functional differences (i.e., if a gaming cabinet has stereo sound, the game application will be able make use of API 302 to use the capability over that of a cabinet having traditional monaural sound).

Game manager 304 provides an interface into game kernel 300, providing consistent, predictable, and backwards compatible calling methods, syntax, and capabilities by way of game application API 302. This enables the game developer to be free of dealing directly with the hardware, including the freedom to not have to deal with low-level drivers as well as the freedom to not have to program lower level managers 330, although lower level managers 330 may be accessible through game manager 304's interface if a programmer has the need. In addition to the freedom derived from not having to deal with the hardware level drivers and the freedom of having consistent, callable, object-oriented interfaces to software managers of those components (drivers), game manager 304 provides access to a set of high level managers 320 also having the advantages of consistent callable, object-oriented interfaces, and further providing the types and kinds of base functionality required in casino-type games. Game manager 304, providing all the advantages of its consistent and richly functional game application API 302 as supported by the rest of game kernel 300, thus provides a game developer with a multitude of advantages.

Game manager 304 may have several objects within itself, including an initialization object (not shown). The initialization object performs the initialization of the entire game machine, including other objects, after game manager 304 has started its internal objects and servers in appropriate order. In order to carry out this function, the kernel's configuration manager 321 is among the first objects to be started; configuration manager 321 has data needed to initialize and correctly configure other objects or servers.

The high level managers 320 of game kernel 300 may include game event log manager 322 which provides, at the least, a logging or logger base class, enabling other logging objects to be derived from this base object. The logger object is a generic logger; that is, it is not aware of the contents of logged messages and events. The game event log manager's 322 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 323 manages the various meters embodied in the game kernel 300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 323 receives its initialization data for the meters, during start-up, from configuration manager 321. While running, the cash in manager 324 and cash out manager 325 call the meter manager's 323 update functions to update the meters. Meter manager 323 will, on occasion, create backup copies of the soft meters by storing the soft meters' readings in EEPROM. This is accomplished by calling and using EEPROM manager 331.

In accordance with still other embodiments, progressive manager 336 manages progressive games playable from the game machine. Event manager 327 is generic, like game event log manager 327, and is used to manage various gaming machine events. Focus manager 328 correlates which process has control of various focus items. Tilt manager 332 is an object that receives a list of errors (if any) from configuration manager 321 at initialization, and during game play from processes, managers, drivers, etc. that may generate errors. Random number generator manager 329 is provided to allow easy programming access to a random number generator (RNG), as a RNG is required in virtually all casino-style (gambling) games. Random number generator manager 329 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 325 has the responsibility of configuring and managing monetary output devices. During initialization, cash out manager 325, using data from configuration manager 321, sets the cash out devices correctly and selects any selectable cash out denominations. During play, a game application may post a cash out event through the event manager 327 (the same way all events are handled), and using a call back posted by cash out manager 325, cash out manager 325 is informed of the event. Cash out manager 325 updates the credit object, updates its state in non-volatile memory, and sends an appropriate control message to the device manager that corresponds to the dispensing device. As the device dispenses dispensable media, there will typically be event messages being sent back and forth between the device and cash out manager 325 until the dispensing finishes, after which cash out manager 325, having updated the credit manager and any other game state (such as some associated with meter manager 323) that needs to be updated for this set of actions, sends a cash out completion event to event manager 327 and to the game application thereby. Cash in manager 324 functions similarly to cash out manager 325, only controlling, interfacing with, and taking care of actions associated with cashing in events, cash in devices, and associated meters and crediting.

In a further example, in accordance with one or more embodiments, I/O board server 315 may write data to the gaming machine EEPROM memory, which is located in the gaming machine cabinet and holds meter storage that must be kept even in the event of power failure. Game manager 304 calls the I/O library functions to write data to the EEPROM. The I/O board server 315 receives the request and starts a low priority EEPROM manager 331 thread within I/O board server 315 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 317 within I/O board server 315, polls (or is sent) the state of buttons every 2 ms. These inputs are debounced by keeping a history of input samples. Certain sequences of samples are required to detect a button was pressed, in which case the I/O board server 315 sends an inter-process communication event to game manager 304 that a button was pressed or released. In some embodiments, the gaming machine may have intelligent distributed I/O which debounces the buttons, in which case button module 317 may be able to communicate with the remote intelligent button processor to get the button events and simply relay them to game manager 304 via IPC messages. In still another embodiment, the I/O library may be used for pay out requests from the game application. For example, hopper module 318 must start the hopper motor, constantly monitor the coin sensing lines of the hopper, debounce them, and send an IPC message to the game manager 304 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a gaming enterprise system 801 is shown in accordance with one or more embodiments. Gaming enterprise system 801 may include one casino or multiple locations (herein referred to collectively as a casino enterprise) and generally includes a network of gaming terminals 803 (including gaming devices 10 of the type as described in FIG. 1), floor management system (SMS) 805, and casino management system (CMS) 807. SMS 805 may include load balancer 811, network services server 813, player tracking module 28, iView (PTM 28), content servers 815, certificate services server 817, floor radio dispatch receiver/transmitters (RDC) 819, floor transaction servers 821 and game engines 823 (where the gaming terminals 803 operate server based, server supported or downloadable games), each of which may connect over network bus 825 to gaming terminals 803. CMS 807 may include location tracking server 831, WRG RTCEM (William Ryan Group Real Time Customer Experience Management from William Ryan Group, Inc. of Sea Girt, N.J.) server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming terminals 803. The various servers and gaming terminals 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming terminals 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803 include various peripheral components that may be connected with USB, serial, parallel, RS-485 or Ethernet devices/architectures to the system components within the respective gaming machine. The GMU (shown as GMU 206 in FIG. 2A) has a connection to the base game through a serial SAS connection. The system components in the gaming cabinet may be connected to the servers using HTTPs or G2S protocols over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming terminals 803 are authenticated using conventional techniques prior to install on the system components.

In various embodiments, any of the gaming devices 803 may be a mechanical reel spinning slot machine, video slot machine, video poker machine, video Bingo machine, Keno machine, or a gaming device offering one or more of the above described games including an interactive wheel feature. Alternately, gaming devices 803 may provide a game with an accumulation-style feature game as one of a set of multiple primary games selected for play by a random number generator, as described above. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in Vallejo et al U.S. Published Application 2008/0139305, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data structure warehouse 835 storing, in individual player accounts, predetermined types of data. This data includes personal data for players enrolled in the casino players club sometimes referred to as a loyalty club. An example of the personal data is the player's name, address, SSN, birth date, spouse's name and perhaps personal preferences such as types of games, preferences regarding promotions, a player's commercial activity such as wagers made during a gaming session and other tracked spending (hotel, dinning, services such a spa) a player rating level usually based at least in part on the player's “spend” with the casino, particularly for gaming, available player comp points (points accumulated also based at least in part upon commercial “spend” activity and which may be redeemed or converted into cash or redeemed in exchange for services or merchandise) and the like. As is known in the industry and according to the prior art, at enrolment the player is assigned a created player account in the player tracking CMS/CMP server 837 and is issued a player tracking card having a machine readable magnetic stripe to tie the player to the activity and their account.

When a player plays a gaming device 10 (or terminal 803) (hereinafter collectively referred to as gaming devices 10), he/she inserts their player tracking card into the card reader 32 (FIG. 1) which communicates data to the CMS/CMP server 837 to accumulate activity data such as wagers (perhaps cumulative wagers between insertion of the card and removal of the card or a time-out period where no wagers have been made), wins or jackpots, session time, gaming terminal associated with the session and the like.

The system 801 may also include electronic transfer of funds functionality. For example, a player having accumulated $100 at a gaming terminal 10 may decide to “cash out” to play another gaming terminal 10. The player, for example using the PTM 28 to initiate communication with the system 801 for example server 837 to upload the value from the gaming terminal 10 into an electronic account associated with the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming terminal 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

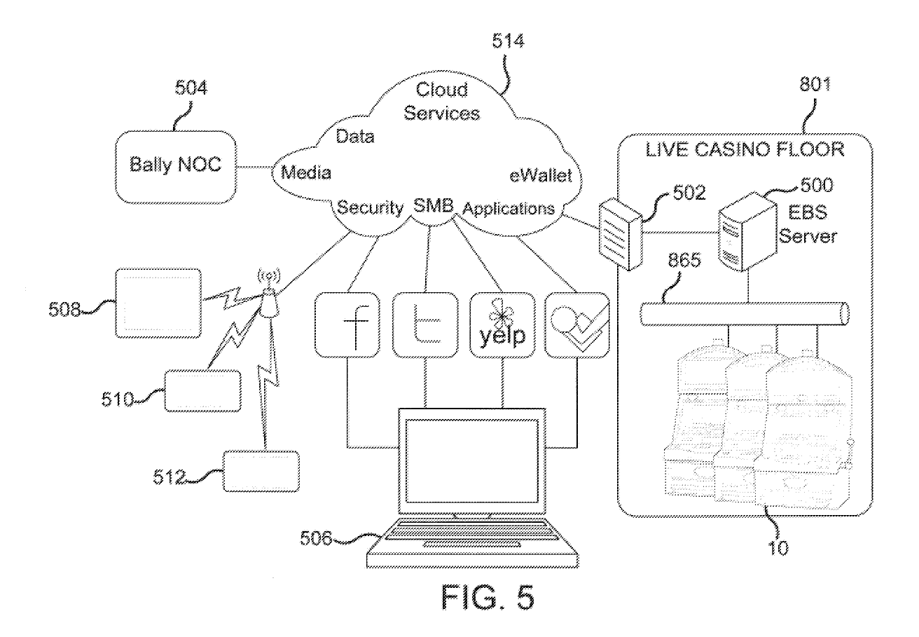

Portions of the present invention may be implemented, augmented or promoted by or through a system as suggested in FIG. 5. At 801 is the gaming enterprise system which may be hosted at a casino property enterprise, across several casino enterprises or by a third party host. As described above the gaming enterprise system 801 has a network communication bus 865 providing for communication between the gaming devices 10 and various servers as described above with respect to FIGS. 4A,B. To provide the functionality illustrated in FIG. 5, a host server 500, such as a Bally Elite Bonusing Server (EBS), is connected to the network communication bus 865 for communication to the gaming system 801, the gaming devices 10 and the various servers and other devices as described above. Through a secure network firewall 502 the host server 500 is in communication with a cloud computing/storage service 514 which may be hosted by the casino enterprise, a licensed third party or if permitted by gaming regulators an unlicensed provider. For example the cloud service 514 may be as provided by Microsoft® Private Cloud Solutions offered by Microsoft Corp. of Redmond, Wash., USA. The cloud service 514 provides various applications which can be accessed and delivered to, for example, personal computers 506, portable computing devices such as computer tablets 508, personal digital assistants (PDAs) 510 and cellular devices such as telephones and smart phones 512. For example the cloud service 514 may provide and support the enterprise applications in association with the feature server 500. The cloud service 513 may also facilitate the delivery of content to user/players by supporting updates and advertising through the enterprise applications to the remote device user/player. The cloud service 514 includes security provide for secure communication with the cloud service 514 between the player/users and the cloud service 514 and between the cloud service 514 and the gaming enterprise system 801. Security applications may be through encryption, the use of personal identification numbers (PINS), biometric identification, location determination or other devices and systems. As suggested in FIG. 5 the cloud service 515 stores or accesses player/user data retrieved from players/users and from the gaming enterprise system 801 and host server 500 and associated one or more data structures.

The players/users may access the cloud service 514 and the applications and data provided thereby through the Internet or through broadband wireless cellular communication systems and any intervening sort range wireless communication such as WiFi, NFC, Bluetooth or the like. The players/users may access the applications and data through various social media offerings such as Facebook, Twitter, Yelp, MySpace or LinkedIn or the like. As described herein the cloud service 514 and enterprise system 801 provides a vehicle through which (a) player group accounts may be initiated, amended or closed, (b) individual and group data may be accessed and viewed, (c) group activities may be supported such a constituent player spending (to perhaps book a stay at the casino enterprise) or group eWallet funding, (d) the enterprise can market to the players, (e) tournament activities may be established or supported, or the like.

On an individual basis, as but an example, a player/user may have an established player account with a casino enterprise. That account may include data such as the player's credit level, their rating and their available comps. At their smart phone 512 the player/user sends a request to the cloud service 514 (perhaps through a previously downloaded application) to request a the status of their available comps such as how many comp points they have and what may be available through redemption of those points (e.g. lodging, cash back, meals or merchandise). The application for the request may present casino promotions, graphics or other advertising to the player/user. The application, to support such a request, would typically require the player/user to enter a PIN or some other unique identifier such as a biometric identifier or tag. The cloud service 514 forwards the inquiry to the host server 500 which, in turn, confirms the identification and retrieves the requested information from the data warehouse 835 or player history database 857 or player tracking CMS/CMP server 837. The information is formatted by the cloud service 514 application and delivered to the player/user. The delivery may be formatted based upon the player/user's device operating system (OS), display size or the like.

The cloud service 514 may also host game applications to provide virtual instances of games for free, promotional, or where permitted, P2P (Pay to Play) supported gaming. Third party developers may also have access to placing applications with the cloud service 514 through, for example a national operations center (Bally NOC 504). A game software manufacturer such as Bally Gaming, Inc. may also provide game applications on its own or on behalf of the casino enterprise.

Other media such as advertising, notices (such as an upcoming tournament) promotions and surveys may also be provided to and through the cloud service 514. When a player/user accesses the cloud service 514 certain media may be delivered to the player/user in a manner formatted for their application and device.

The cloud service 514 enables the casino enterprise to market to and foster player loyalty. To drive such interaction various incentive programs may be employed including, as described above, users earning or being awarded mystery game chances which may be redeemed at their next visit to the casino enterprise or, where permitted, during play on their remote devices. As described herein the cloud service 514 enables the user/player to access and interact with their one or more virtual objects.

The cloud service 514 may be replaced or augmented with an Internet accessible enterprise web portal to provide the functionalities described herein.

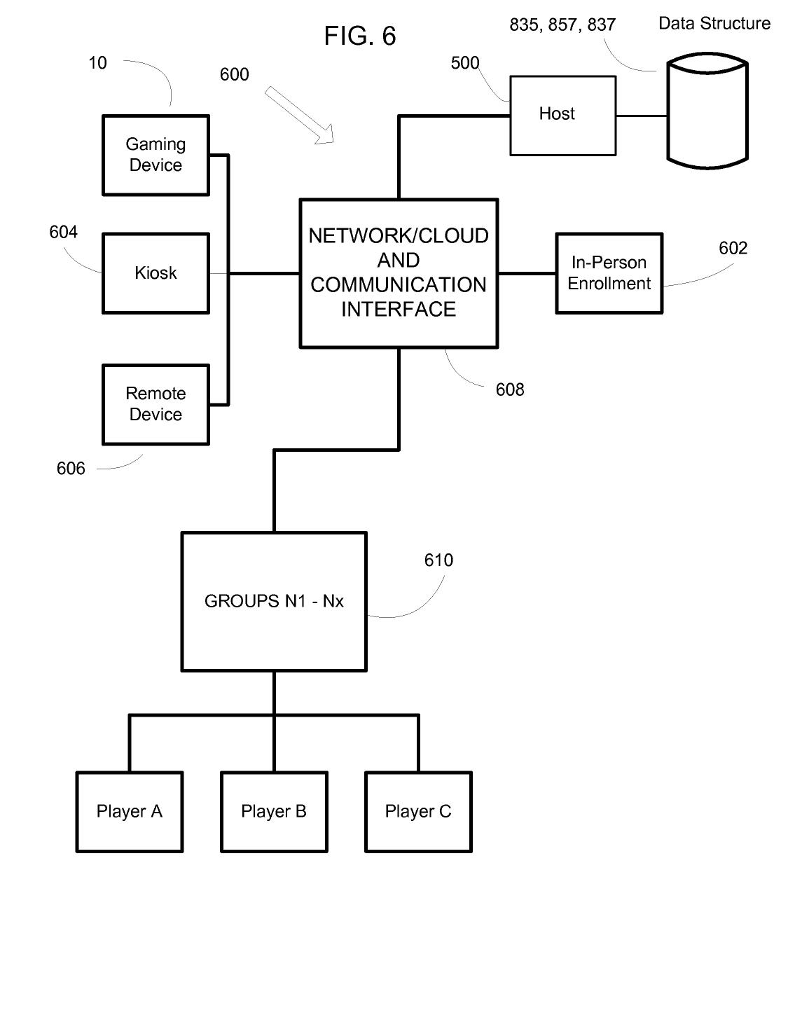

Turning to FIG. 6 according to an embodiment of the present invention there is shown a system 600 for the initiation and population of one or more group accounts. Apparatus is provided which is in communication with the host server 500 (which may include one or more servers) which, in turn, can access one or more data structures 600 such as, for example, data warehouse 835 or player history database 857 or player tracking CMS/CMP server 837 storing player account data as described above. The aforementioned apparatus may include an enrollment station 602 for live, in-person enrollment and group configuration by an attendant. The enrollment station 602 may be associate or combined with the enterprise loyalty club enrollment desk. Alternatively players may arrange their groups/sub-groups as hereinafter described at a gaming device 10, a kiosk 604 or through a remote device 606 such as a personal computer, portable computing devices such as computer tablet, personal digital assistant (PDA) and cellular devices such as cellular telephones and smart phones as suggested above with respect to FIG. 5. Regardless of the group enrollment apparatus, one or more players identify the constituent players of the group. This identification can be done by name, player card, PIN or other identifier. For example, at a kiosk 604 at the casino enterprise a Player A may elect to form a group. The formation of the group may include providing a group name such as the “Gamblers”. Player A swipes their player card in a card reader at the kiosk 604 and using a keypad and user interface establishes the group. At this step Player A may identify at least some of the other constituent players. As but an example, Player A would type in a player's name at the kiosk 604 whereupon the host 500 would search established player account records to display one or more player's on the kiosk display for Player A to select to include in the group. The interface between Player A and the host 500 is provided through a network 608 which, as described above, may be a WAN, LAN or wireless network. Where Player A is remote to the casino enterprise the network may be the Internet or a broadband network including cloud services 514 as described above. As depicted, through this process at 610 Groups N₁-N_{X} of players are defined. In this example the Gamblers group (Group N₁) may have players A-C.

To confirm association into the groups each player must proactively participate in the formation or assent to becoming a member. When, for example, Players B and C remotely log onto the casino enterprise website or insert their player's card into a card reader at a gaming device 10 in the casino enterprise, a message is generated informing Players B and C of Player A's formation of the group and asking them to confirm their membership in the group. Alternatively player A can inform Players B and C of the group and these players can proactively join the group at a kiosk 604, gaming device 10 or remote device 606.

Also alternatively the casino enterprise or a third party may configure a group. For example, where a tour (a/k/a “junket”) is going to visit the casino the tour operator/casino may arrange the group for the players.

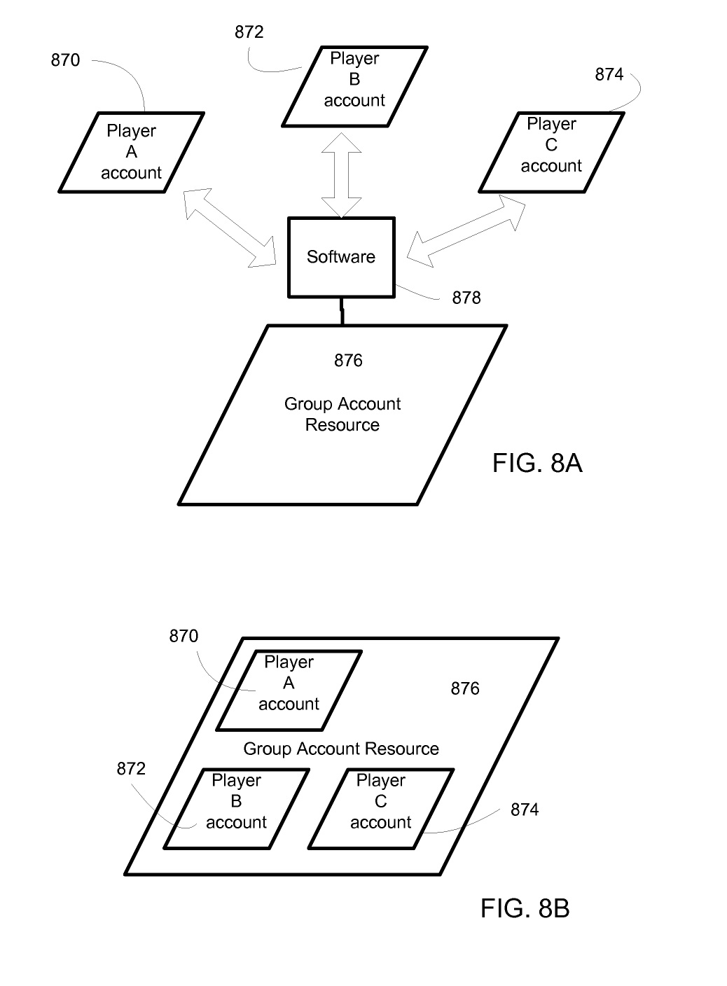

FIGS. 8A and 8B illustrate how the groupings may be associated by the host 500. As described above, each player has an individual player account in the casino loyalty program. This account is uniquely tied to the individual player for the purposes described above. For example, Players A, B and C may have individual data files in one or more data structures such as data warehouse 835 and/or player history database 857 and/or player tracking CMS/CMP server 837 shown as 870, 872 and 873 respectively. These accounts are maintained, managed and serviced regardless of whether or not the player is a member of a group according to the embodiments of the present invention. For example, where the features of the present invention are incorporated into a casino enterprise already having an existing loyalty program the individual accounts 870, 872 and 874 are retained. With reference to FIG. 8A when a player group is created, the host 500 generates a player group resource 876 which supports the group functionalities described herein. The player group resource 876 refers to one or more software programs and at least cached data which provide the functionalities to support the group functions described. In the embodiment of FIG. 8A the group account resource 876 may be a resource supported by a software engine 878 to point to the established individual accounts. The tracked activities of the individual players A, B, C are stored in the individual accounts 870, 872, 874 but where group data (such as data aggregated from the activities of constituent players) is required, the software engine 878 points to the individual accounts 870, 872, 874 to obtain the data to satisfy a group account resource 876 request.

Alternatively, as suggested in FIG. 8B, when a group is formed the individual player accounts 870, 872, 874 (or preferably copies) are moved or copied into the group account resource 876. There is no pointer and tracked data is either posted to the accounts and their copies.

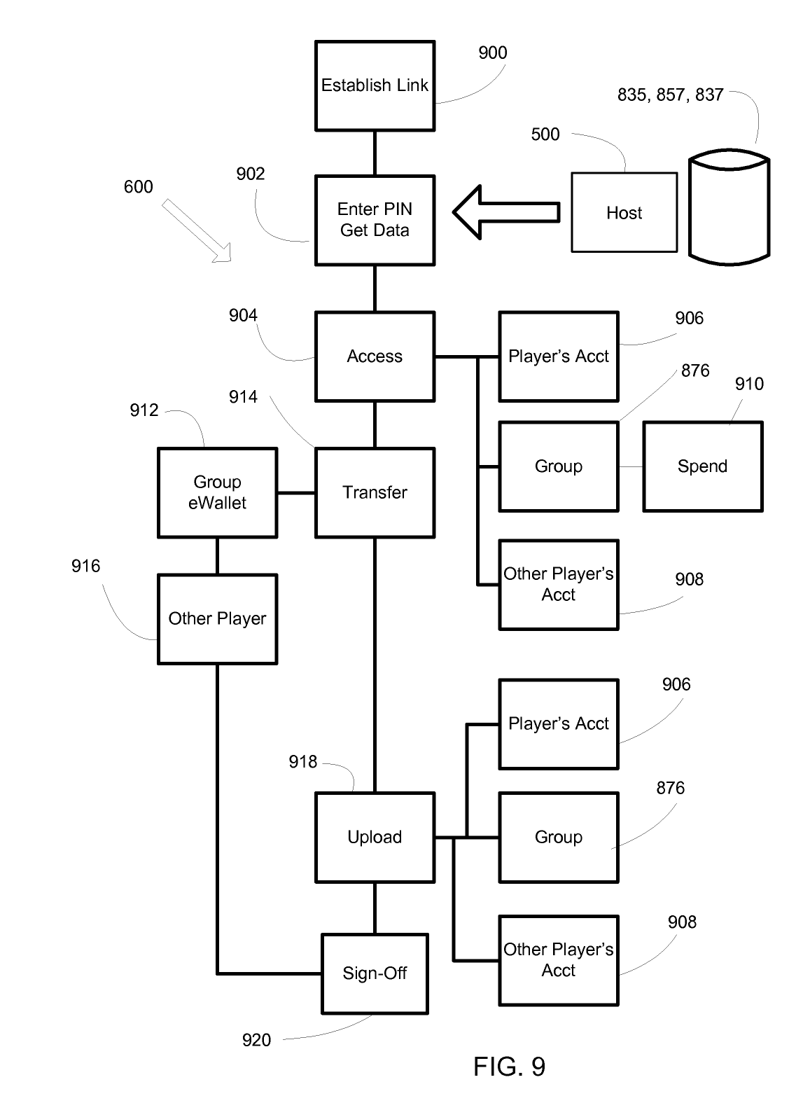

A feature of the present invention includes the establishment, management, maintenance and reporting relative to a group eWallet of funds accessible by the constituent members of the group for commerce with the enterprise such as for gaming. When a group is established and configured the group account resource 876 creates an electronic account eWallet data file as well as any access and transaction rules established by the players and/or enterprise. FIG. 9 is a logic diagram illustrating the system and method for funding, managing and accessing the eWallet. At 900 the players establish a communication link between their device 10, 604, 606 and the system 600. As discussed above this link may be by the player using their portable device 606, e.g. smart phone or if the player does not have such a device and is at a gaming device 10 by using a system interface. To use a portable device 606 the player would first download a software application from a provider such as the casino enterprise. At 902 the player enters a PIN and other information, e.g. player account number, to identify and authenticate himself/herself to the system. In lieu of a PIN biometric identification such as a facial scan may be used. Once identified and authorized the player at 904 can access various account data files such as their individual account data file 906 and the group account resource 876 data including the eWallet file. In an embodiment the player may also access other group member's account files 908. The group access may be confined to only data with respect to the group account resource 876. That is, only the player can access their own individual account 906 maintained apart from any group affiliation but all player's can access their own and each other's account data files tied to and supporting the group account resource 876. In some instances the data maintained in the individual account and group account for the player may be common such as player tracking information acquired since establishment of the group. However tracking data acquired before establishment or after closure of the group or personal information of a player would not be accessible to the other members. Further the system 600 may be configured to only copy data from constituent player accounts to the group account resource 876 which is pertinent to group functions. At 910 the constituent players may view the group account resource 876 data file in regards to group as well as individual spending from the eWallet.

When a player has accessed the group account resource 876 in addition to viewing group account data the player may access the group account eWallet 912 to transfer funds at 914. As but an example where the player has accessed the account from the gaming device 10 interface the player can download $50 from the group account resource 876 eWallet 912 to the gaming device 10 for gaming. Where the player is using their portable device 606 at a gaming device 10 a link is established between the portable device 606 and gaming device 10 to facilitate the transfer of the funds to the gaming device 10. The link may be a wireless communication network such as Bluetooth technology (IEEE 802.15.1), WiFi (IEEE 802.11) or other suitable wireless communication protocols. Returning to FIG. 1, there is graphically illustrated a portable device 606 (e.g. Smart phone) as well as a wireless transceiver 50 for the gaming device 10 and in communication with the gaming device processor(s). In an embodiment the system 600 may download the funds to and through the portable device 606 to the transceiver 50 and gaming device 10 and onto the game's credit meter. In an embodiment the wireless communication between the portable device 10 and portable device 606 instructs the gaming device 10 to communicate through its LAN/WAN network to request the desired funds through the network bus 865 which are downloaded to the gaming device 10 credit meter. In a further embodiment the portable device 606 establishes near field communication with the gaming device 10 and when the funds request is made one or each of the portable device 606 and transceiver 50 sends a wireless request to the system 600 for transfer of the funds to the gaming device 10. The request would include the group resource 876 eWallet 912 account information, target gaming device 10 destination and the amount requested. The transfer of funds from the eWallet 912 may be wirelessly or over the Ethernet network.

Where the player requests funds from the eWallet 912 for gaming from a remote terminal such as a home PC or for spending remote from gaming device 10 such as to purchase spa services, the funds may be transferred in a like manner to the payment terminal. Group players may download funds to a PC at home or payment kiosk. The player first establishes a link and establishes their identity and the funds are downloaded either directly or through the portable device 606.

To fund the eWallet 912 at the group account resource 876 the players may use a kiosk at the casino enterprise, deposit funds at the casino cage or transfer funds via bank, payment escrow site such as PayPal or credit card transfer or the like. If so configured by the players, individual contributions may be tracked for deposited funds. Thus each would know the contributions by the other player(s).

Returning to FIG. 9 at 916 players may transfer funds inter se. For example Player B, as a “gift” or upon request from Player A, may transfer funds to Player A through (or around) the group eWallet 912. Other players may of course debit from and credit to the eWallet 912 in the manner described above. Preferably all transactions with the eWallet 912 (debits, credits) are tagged with data indicating at least the source of the deposit/withdrawal. This data may include a time, location and source such as kiosk, casino cage, funds transfer or the like. Thus players of the group may view the details of the group eWallet 912 transactions.

At 918 players may also upload funds from the gaming device 10 to the player's account 906, the group account resource 876 eWallet 912 or to another player's individual account 908. The system and method of the present invention is also configured to upload at 918 defined information such as; player tracking information (coin-in, coin-out, jackpots, session elapsed time, machine ID, machine or gaming table location, denomination or other tracked information). For example other players of the group may desire to, from time to time or in real time, view the group's eWallet account information such as starting balance, transfers, uploads and current coin-in versus coin-out to determine the group's net win to date. The uploaded information can also be used to enable features such as group “chat”, member location, communication and challenges between groups and/or offers to players to join a group.

When a player is finished with the group interactivity at 920 he/she signs off and terminates the communication link.

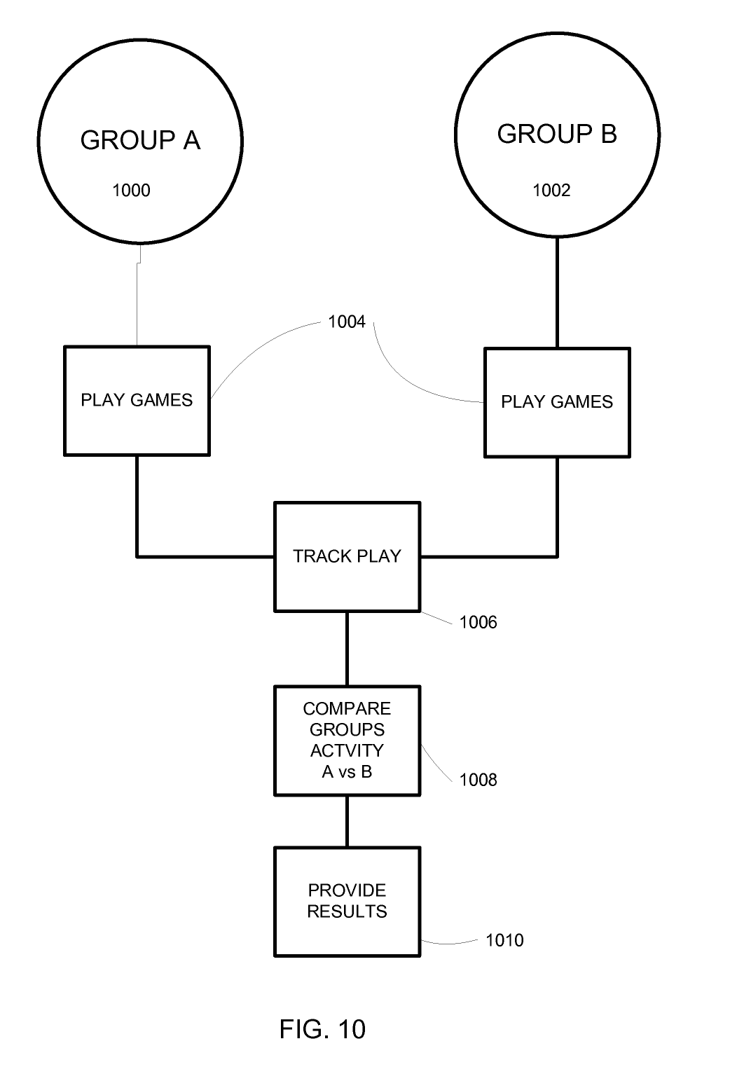

Referring now to FIG. 10 an embodiment of a group competition feature of the present invention is shown. A group of players may engage in a competition between one or more other groups. In an example, the players of Group A may compete with the players of Group B to fulfill a challenge and/or goal. In this exemplary example the goal may be to have the most amount won on video poker machines during a time period such as over a defined weekend period. The enterprise may also configure and announce the competition. Thus Group A 1000 of six players may be engaged in the competition with the five players of Group B 1002. At 1004 the players of the groups play the designated video Poker games which play is tracked by the system. The wins at the machines credits to each gaming device are tracked by the system at 1006 and the data is stored in the group resource account 876. Player of each group may view, in real time, the performance of their group as well as the performance of the individual members. Events such a major jackpots would warrant special reporting to the group members. The system and method compares at 1008 the designated group competitive activity (amounts won) between the groups and at the end of the competition period at 1010 provides the results to the groups. The enterprise may award prizes such as gifts, credits to the group eWallet, comp points or the like.

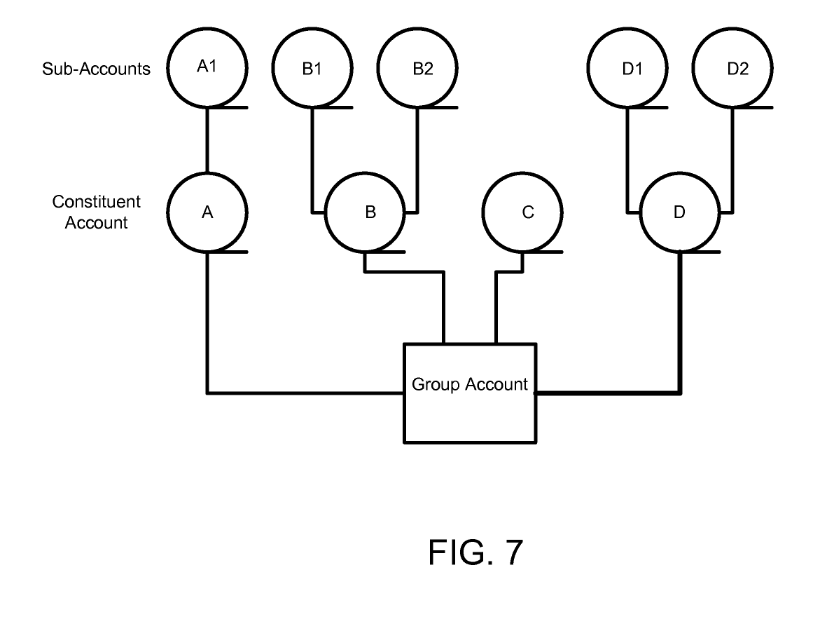

Turning to FIG. 7 an embodiment for the establishment of group and subgroup accounts is illustrated. As illustrated the group account includes players A-D. This tier or players may be the original members of the group. Each group member may enlist other players in the group or may establish a sub-group. In this example Player A has enlisted a player A1 into a subgroup, Player B has enlisted Players B1-B2, Player C has not enlisted any sub-group players and Player D has enlisted Players D1-D2. These players may be deemed played of the group and be entitled to the access the group account resource 876 or may be only entitled to view data for their sub-group. In an embodiment the group and/or enterprise may award benefits to players who enroll additional players into the group. Where sub-groups are established tournaments/competitions may be had between sub-groups.

The players or host may impose restriction on fund access such as aggregate group spending limits, individual spending limits, spending limits for certain activities, e.g. each constituent player may spend no more than $500 for download to a gaming device 10 in a 24 hour period, Player C is limited to $300 per 24 hour period or the like. Other limits may relate to the type of gaming such as no more than $100 may be downloaded for slot machine play. Time period limitations may be imposed such as the eWallet is only open for funding from Friday at noon to Sunday at noon.

The foregoing description focused upon implementations and embodiments related to a casino enterprise. It should be understood that the inventions described herein can be utilized by other brick and mortar enterprises such as department store chains, grocery store chains, convenience stores, gasoline stations and the like. Further several aspects are applicable to Internet based enterprises.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A system for providing group features to players for a casino enterprise hosting a plurality of gaming terminals each having apparatus for identifying a player at a gaming terminal and including (i) a host computer and data structure storing data corresponding an account for each player and (ii) a communication network for providing communication between said terminals and said host computer and wherein players possess portable devices having a processor, display and memory, said system comprising:
a system interface at each gaming terminal providing for player access to said host computer, each gaming terminal including a terminal video display;
apparatus in communication with said host computer to define at one or more of said host computer and data structure player account groups N₁-N_{X} and to fund for each a group eWallet, each group including two or more players;
said player portable devices configured to wirelessly communicate with one or both of said gaming terminals and host computer;
said (a) system interface and (b) player portable devices configured to access a player group by a constituent player thereof to transfer funds between their group eWallet and the gaming terminal, said host computer and data structure configured to record said transaction and constituent player information;
said gaming terminals, system host and data structure configured to track and record gaming activity data for each player of a group account and aggregate group account activity; and
said host computer configured to provide data over said network to at least one of said terminal video display and portable device display to display data corresponding to said group account activity and activity for each player account thereof; and
said host computer configured to establish a group competition parameter, to compare for participating account groups to said competition parameter and to control one or more of said terminal display and portable device display to display data comparing said parameters for said participating account groups.

2. The system of claim 1 wherein one or more of said portable devices are configured for near field communication, said system comprising a terminal near field communication device disposed proximate said gaming terminals to provide for said transfer of funds and display data corresponding to said group account activity and activity for each player account thereof.

3. The system of claim 1 comprising said host computer configured to establish a group competition parameter of group account wagering during a predetermined time period.

4. The system of claim 1 wherein said gaming at said gaming terminal results in winning and losing outcomes and where for each wining outcome the player receives an award, said host computer configured to establish a group competition parameter of group account awards during a predetermined time period.

5. The system of claim 1 comprising said apparatus in communication with said host computer for defining at one or more of said host computer and data structure said player account groups N₁-N_{X} configured for adding or deleting player accounts from a group.

6. The system of claim 1 comprising said (a) system interface and (b) player portable devices configured to access a player group by a constituent player A thereof to engage in a transaction selected from the group of transferring funds between the group eWallet and player A gaming terminal and transferring funds to another gaming terminal being played by a group player B.

7. The system of claim 1 comprising said host computer configured to provide real-time data over said network to at least one of said terminal video display and portable device display to display data corresponding to said group account activity and activity for each player account thereof.

8. A method for providing group features to players for a casino enterprise hosting a plurality of gaming terminals each having a terminal display and apparatus for identifying a player at a gaming terminal and including (i) a host computer and data structure storing data corresponding an account for each player and (ii) a communication network for providing communication between said terminals and said host computer and wherein players possess portable devices having a processor, display and memory, said method comprising:
providing for players to access to said host computer when using a gaming terminal;
enabling the definition at one or more of said host computer and data structure player account groups N₁-N_{X} and the funding for each a group eWallet, each group including two or more players;
said player portable devices wirelessly communicating with one or both of said gaming terminals and host computer;
configuring said (a) system interface and (b) player portable devices for accessing a player group account by a constituent player thereof for transferring funds between the group eWallet and the gaming terminal and arranging said host computer and data structure for recording said transaction and constituent player information;
tracking and recording gaming activity data for each player of a group account and aggregate group account activity;
providing data over said network to at least one of said terminal video display and portable device display to display data corresponding to said group account activity and activity for each player account thereof; and
establishing a group competition parameter, comparing tracked activities for participating account groups to said competition parameter and controlling one or more of said terminal display and portable device display to display data comparing said parameters for said participating account groups.
